(19) United States
(12) Patent Application Publication
(10) Pub. No.: US 2025/0070303 A1
(43) Pub. Date: Feb. 27, 2025

(54) HIGH DENSITY COOLING JACKET

(71) Applicant: FCA US LLC, Auburn Hills, MI (US)

(72) Inventors: Venkata Krishna Mohan Chagarlamudi, Rochester Hills, MI (US); Skreekanth Surapaneni, Oakland, MI (US); Uday Kiran Mahakali, Novi, MI (US)

(21) Appl. No.: 18/455,825

(22) Filed: Aug. 25, 2023

(51) Int. Cl. H01M 10/625; B60L 50/64; B60L 58/26; H01M 10/613; H01M 10/63; H01M 10/6551; H01M 10/6566; H01M 10/6568; H01M 50/271

(52) U.S. Cl. CPC H01M 10/625; B60L 50/64; B60L 58/26; H01M 10/613; H01M 10/63; H01M 10/6551; H01M 10/6566; H01M 10/6568; H01M 50/271; H01M 2220/20

(57) ABSTRACT

A battery high density cooling jacket has a battery pack including a housing and at least one battery cell. The battery housing includes an air inlet passage and an air outlet passage enabling an air flow to pass over the at least one battery cell. A cooling jacket cover housing. The cooling jacket housing has an inlet and an outlet. A movable door is positioned adjacent the inlet to enable the air flow into the cooling jacket cover when the door is open. The door opens and closes based on a cooling air flow demand. The air flow passes along the exterior of the battery housing and along an interior of the battery housing.

### FIELD

The present disclosure relates to high voltage battery pack cooling and, more particularly, to a high density cooling jacket.

### BACKGROUND

This section provides background information related to the present disclosure which is not necessarily prior art.

In high voltage battery packs, the cells or batteries in the battery packs should operate within a temperature range to ensure optimum performance during harsh drive cycles. Additionally, most electronic components require operation at acceptable temperature ranges.

Current cooling solutions do not provide for uniform temperature across the battery cells due to the localized effects of coolant flow, cold plate set ups or due to the presence of a heat source, like an exhaust adjacent the battery pack. The convection effects of a heat source add to the imbalance of the battery cells temperatures.

Currently, passive air is utilized to cool batteries that use natural convection to remove heat from the battery cells. Additionally, the cells may be cooled down or heated by a dedicated coolant loop that exchanges its heat with a chiller heat exchanger. The passive systems are insufficient and ineffective to quickly remove heat from the battery cells. A dedicated coolant loop or chiller, though widely used, needs dedicated heat exchangers which are extremely costly and inefficient to implement. The placement of the cells on a coolant plate causes non-uniformity across the cell. The area in contact with the cooling plate is much colder compared to other areas farther away. Thus, there is no cooling system for cooling plates and dedicated cooling circuits available for internal or high voltage batteries, electrical or electronics, in the underbody or rear of the vehicle to achieve uniform cooling across the cells in the battery and the cell body itself.

The present disclosure provides a jacket strategically positioned to harness the underbody cold ram air to cool the components like the high voltage battery/electronics/electrical components that are located in the underbody or rear underbody regions of the vehicle. The inlet of the jacket is positioned downstream of a modified engine belly pan.

The present disclosure utilizes the available ram air to provide a cost effective solution to maintain the cell temperature across the battery pack as well as within the cell. The present disclosure provides a split cooling capacity utilizing ram air for both the exterior and interior of the battery pack simultaneously. The present disclosure utilizes the available cold ram air for cooling the air during demanding drive cycles and hotter environments. Also, a dedicated cooling loop takes care of the cooling needs of the battery's underbody while the ram air is available to help reduce the overall cooling system size and cost. The present disclosure reduces high chiller loads, eliminates the dependency of components on extra coolant loop to minimize weight and cost. This provides uniform cooling which is a requirement for the batteries.

### SUMMARY

This section provides a general summary of the disclosure, and is not a comprehensive disclosure of its full scope or all of its features.

According to a first aspect of the disclosure, a battery high density cooling jacket comprises a battery pack that includes a housing and at least one battery cell. The battery housing includes an air inlet passage and an air outlet passage to enable an air flow to pass over the at least one battery cell. A cooling jacket cover housing covers the battery housing and includes an inlet and outlet. A movable door is positioned adjacent the inlet to enable the air flow into the cooling jacket cover when the door is open. The door opens and closes based on a cooling air flow demand. Air flow passes along the exterior of the battery housing and along an interior of the battery housing. The door is variably opened based on a desired temperature of the battery pack. A plurality of channels is formed between the battery housing and the battery jacket cover. The channels are defined by a plurality of walls. The walls dissipate heat from the battery back. A cooling plate may be positioned adjacent the battery pack to dissipate heat. The cooling plate includes fins extending to the cooling jacket cover. The fins define the channel enable air flow passage to dissipate heat. A controller opens and closes the door based on battery pack temperature. A liquid coolant loop is coupled with the battery pack. The liquid coolant loop is positioned between the battery housing the jacket cover and inside the battery housing. The coolant loop operation is independent of the air flow. The coolant loop operation may heat the at least one battery cell.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of the underbody of a vehicle.

FIG. 2 is a schematic elevation view of the vehicle of FIG. 1.

FIG. 3 is a perspective schematic view of the high density coolant flow jacket.

FIG. 4 is schematic cross-section view of FIG. 3.

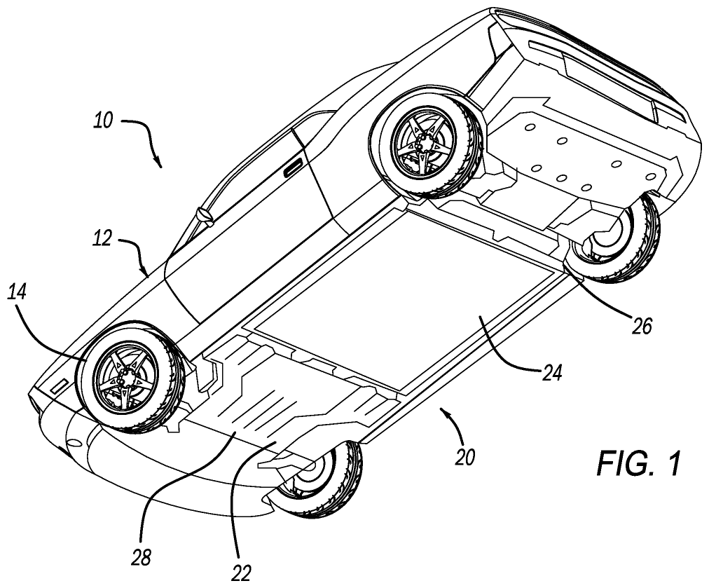

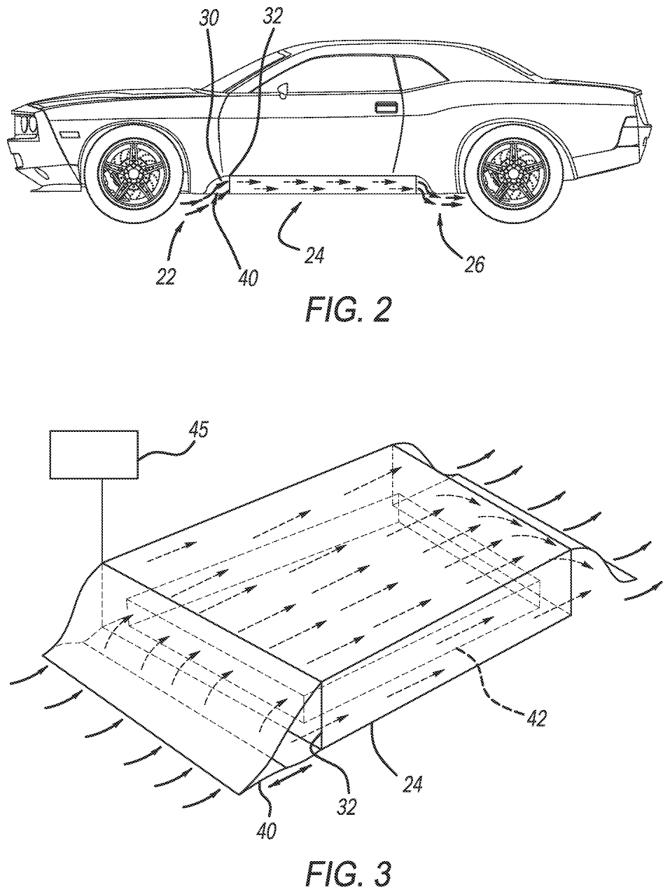

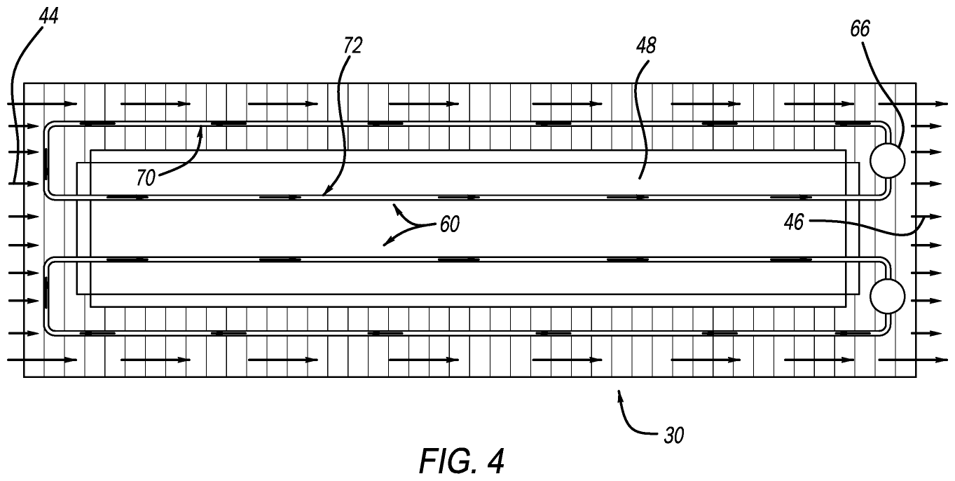

Corresponding reference numerals indicate corresponding parts throughout the several views of the drawings.

### DETAILED DESCRIPTION

Example embodiments will now be described more fully with reference to the accompanying drawings.

Turning to the figures, a vehicle is illustrated and designated with the reference numeral 10. The vehicle includes a body as well as wheels 14. The underside of the vehicle includes an active ram system 20. The system includes a belly pan 22, an outlet 26 and a high density cooling jacket 30. The belly pan 22 includes a substantially flat pan 24 secured to the underbody of the vehicle. The pan 24 terminates into a kick up portion 28. The kick up portion 28 includes an arcuate pin portion 32 that extends towards the top of the vehicle. The kick up portion 30 is positioned adjacent the high density cooling jacket 30.

The jacket 30 includes a cover housing 42, an inlet 44, an outlet 46. The cover housing 42 includes a battery pack 48 positioned within the cover housing 42. Also, the cover housing 42 includes a movable door 50 that opens and closes the inlet. The door 50, in a closed position, prohibits the ram air flow from entering through the inlet 44. In an open position, the door slides rearward into the high density cooling jacket 30. The door 50 is open to enable the ram air to enter into the inlet 44 and subsequently into the high density cooling jacket 30.

The door 50 is controlled by a battery thermal management system or similar controller 52 that senses the amount of air required to maintain the temperature of the components within the jacket 30. The active door mechanism 50 closes or opens based on the cooling flow demand required. Thus, the thermal management system or controller 52 operates the door 50 to move it between an open and closed position.

Thus, for example, on a cold day, when the cooling demand for the components is low, the door 50, at the inlet 44, would remain shut. The door 50 would open variably along its path to enable a desired amount of ram air to enter into the high density cooling jacket 30 to a maximum fully open door position.

The battery pack 48 is positioned inside of the cover housing 42. The battery pack generally includes a cooling plate 54 surrounding the battery pack 48. The cooling plate 54 may include a plurality of plates positioned around the battery pack 48.

A plurality of fins 56 are positioned between the cooling plates 54 and the cover housing 42. Thus, the fins 56, along with the wall of the cover 42, define channels 58 to direct the ram air flow through the high density cooling jacket 30. The fins 56 are positioned adjacent to the cooling plates 54 and are manufactured from a conductive material to dissipate the heat from the battery pack to the channels so that a surface area of the fins 56 is contact by the ram air flow to cool the battery pack 48. The fins 56 surround the battery pack 48 to provide channels that surround the battery pack. Thus, this provides a supplemental active air cooling with high speed air flow with approximately 360° coverage around the high voltage battery pack 48, electronic components or the like while the vehicle is in motion. The air that enters into the high density cooling jacket is directed around the battery pack 48 to provide a temperature range to ensure optimum performance during harsh driving cycles. Also, the temperature is substantially uniform across all of the cells within the battery pack 48 due to the approximate 360° coverage around the battery pack 48.

A coolant loop 60 is positioned within the battery pack 48. The coolant loop 60 includes a pair of loops 64 with a header 66 to enable ingress and egress of the fluid to and from the battery pack 48. Generally, the loops include a portion 70 outside of the battery pack that may be cooled by the ram air flow. An additional portion 72 of the loop 60 is positioned inside of the battery pack 48. The loop 60 is filled with a liquid coolant to provide coolant inside of the battery pack 48. The coolant loop 60 serves the regular cooling needs of the high voltage battery/module or electronics that are placed within the high density cooling jacket 30. The cooling loop 60 serves the cooling needs when there is extra cooling demand that cannot be satisfied by the dedicated coolant loop. This also may be utilized as a heating loop during cold weather.

The outlet 46 is located at the rear or exit of the high density cooling jacket 30. This enables the air flow to pass through the jacket 30 along the channels without obstruction. The cover housing 42 may include extended pieces at the outlets 46 to direct the flow to other components downstream of the battery pack 48.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A battery high density cooling jacket comprising:
a battery pack including a housing and at least one battery cell, the battery housing including an air inlet passage and an air outlet passage enabling an air flow to pass over the at least one battery cell;
a cooling jacket cover, housing the battery housing, includes an inlet and an outlet, a movable door is positioned adjacent the inlet to enable the air flow into the cooling jacket cover when the door is open, the door opens and closes based on a cooling air flow demand; and
the air flow passes along the exterior of the battery housing and along an interior of the battery housing.

2. The battery high density cooling jacket of claim 1, wherein the door is variably opened on a desired temperature of the battery pack.

3. The battery high density cooling jacket of claim 1, further comprising a plurality of channels between the battery housing and battery jacket cover.

4. The battery high density cooling jacket of claim 3, where the channels are defined by a plurality of walls.

5. The battery high density cooling jacket of claim 4, wherein the walls dissipate heat from the battery pack.

6. The battery high density cooling jacket of claim 1, wherein a cooling plate is adjacent the battery pack for dissipating heating.

7. The battery high density cooling jacket of claim 1, wherein the cooling plate includes fins extending to the cooling jacket cover.

8. The battery high density cooling jacket of claim 7, wherein the fins define channels for enabling air flow passage to dissipate heat.

9. The battery high density cooling jacket of claim 1, wherein a controller opens and closes the door based on the battery pack temperature.

10. The battery high density cooling jacket of claim 1, further comprising a liquid coolant loop coupled with the battery pack.

11. The battery high density cooling jacket of claim 10, wherein the coolant loop is positioned between the battery housing and the jacket cover and inside the battery housing.

12. The battery high density cooling jacket of claim 10, wherein the coolant loop operation is independent of the air flow.

13. The battery high density cooling jacket of claim 10, wherein the coolant loop operation heats the at least one battery cell.

14. A battery high density cooling jacket comprising:
a battery pack including a housing and at least one battery cell, the battery housing including an air inlet passage and an air outlet passage enabling an air flow to pass over the at least one battery cell;
a cooling jacket cover, housing the battery housing, includes an inlet and an outlet, a movable door is positioned adjacent the inlet to enable the air flow into the cooling jacket cover when the door is open, the door opens and closes based on a cooling air flow demand;
the air flow passing along the exterior of the battery housing and along an interior of the battery housing; and
a liquid coolant loop coupled with the battery pack.

15. The battery high density cooling jacket of claim 14, wherein the door is variably opened on a desired temperature of the battery pack.

16. The battery high density cooling jacket of claim 14, wherein a cooling plate includes fins extending to the cooling jacket cover.

17. The battery high density cooling jacket of claim 16, wherein the fins define channels for enabling air flow passage to dissipate heat.

18. The battery high density cooling jacket of claim 14, wherein a controller opens and closes the door based on the battery pack temperature.

19. The battery high density cooling jacket of claim 14, wherein the coolant loop is positioned between the battery housing and the jacket cover and inside the battery housing.

20. The battery high density cooling jacket of claim 14, wherein the coolant loop operation is independent of the air flow.
